(19) United States
(12) Patent Application Publication
(10) Pub. No.: US 2018/0352787 A1
(43) Pub. Date: Dec. 13, 2018

(54) NECTAR POUCH FOR HUMMINGBIRD FEEDER

(71) Applicant: Teters Floral Products, Inc., Bolivar, MO (US)

(72) Inventor: Ntxhuav Kong, Nixa, MO (US)

(73) Assignee: Teters Floral Products, Inc., Bolivar, MO (US)

(21) Appl. No.: 15/617,062

(22) Filed: Jun. 8, 2017

(51) Int. Cl. A01K 39/02; A01K 39/01

(52) U.S. Cl. CPC A01K 39/0206; A01K 39/02; A01K 39/01

(57) ABSTRACT

A nectar pouch for use with a hummingbird feeder includes a main body forming an interior cavity for containing liquid nectar. A resealable opening in the upper end of the pouch allows the pouch to be sealed with liquid nectar inside for distribution, and to further be attached to a hummingbird feeder for dispersion of the liquid nectar when the pouch is inverted. A tab is hingedly attached to the bottom of the pouch, moveable between an extended position and a folded position. In the extended position the tab allows the nectar pouch and attached hummingbird feeder to be suspended from a structure. When folded, the tab lies flush with the bottom end to allow the pouch to stand upright and to allow the pouch to be package in standard flat bottomed containers while standing upright. Various embodiment of the nectar pouch are shown and described.

### BACKGROUND

Various types of bird feeders are typically used for a common purpose, which is to feed birds and to attract birds to an area they may not otherwise go. For example, feeders are often located in residential backyards for the purposes of attracting birds for birdwatching. Feeders intended to attract specific types of birds are known in the art—for example seed feeders are commonly used to dispense specific types of seed to attract birds favoring that type of seed, while nectar feeder provide and dispense nectar—a liquid sugar mixture—are specifically intended to attract hummingbirds as the nectar is particularly attractive to that type of bird.

Nectar, however, is much more difficult to use and fill or re-fill than seed as the liquid is more prone to spillage than birdseed, and any spillage or overflow results in the sticky liquid covering the surrounding area. Furthermore, refilling a conventional hummingbird feeder with nectar typically involves mixing the nectar in one container (or buying a container of pre-mixed nectar) and transferring it to the feeder's container using a funnel, with the mixing and transfer processes increasing the risk of spillage and wasted product, and creating the need for further cleanup once the feeder has finally been refilled with nectar.

Thus, it can be seen that there remains a need in the art for an improved way of supplying nectar for use with a hummingbird feeder that minimizes the chances for spillage and wasted product, and that does not incur the downfalls associated with known types of feeders and refills.

### SUMMARY

Embodiments of the invention are defined by the claims below, not this summary. A high-level overview of various aspects of the invention is provided here to introduce a selection of concepts that are further described in the Detailed-Description section below. This summary is not intended to identify key features or essential features of the claimed subject matter, nor is it intended to be used in isolation to determine the scope of the claimed subject matter. In brief, this disclosure describes, among other things, one or more embodiments of a nectar pouch for use with a hummingbird feeder.

In one embodiment, the present invention is directed to a nectar pouch for use in conjunction with a hummingbird feeder attached to the pouch. The nectar pouch is a cylindrical shaped container extending between first and second ends, with a sealable opening at the first end and a closed second end. The sealable opening at the first end allows liquid nectar to flow from the pouch into an attached bird feeder, where the nectar is dispersed to feeding stations or nozzles positioned along the feeder. In one embodiment, the sealable opening comprises a threaded neck on the first end of the pouch and a similarly threaded cap that mates with the threaded neck. A tab is hingedly attached to the second, closed end of the nectar pouch, the tab movable between a folded position in which the tab lays essentially flat against the bottom surface of the nectar pouch, and an extended position in which the tab stands approximately perpendicular to the bottom surface.

In one aspect, the sealable opening allows the nectar pouch to be pre-filled with nectar and the opening then sealed for shipment. The unique shape and structure of the pouch allows it to be easily packaged for shipment and transport. The shape and structure of the pouch also allows for easy and effective display of the pouches in a retail setting. An end user can use the pre-filled pouch to supply nectar to a hummingbird feeder without requiring refill of an existing container on the feeder and without requiring mixing of nectar solution and/or the use of additional containers or fill equipment.

In another aspect, the nectar pouch includes a sealable opening at one end that allows liquid nectar to flow from the pouch into the bird feeder so that the bird feeder can disperse and dispense the nectar to feeding stations or nozzles positioned on the feeder. The opening of the pouch can be connected to the hummingbird feeder such that nectar can flow from the pouch to the feeder. The tab at the opposite end of the pouch allows it to be suspended from a structural support via a string, tie, chain, hook, or the like. When suspended, the pouch can support the hummingbird feeder attached thereto.

### DESCRIPTION OF THE DRAWINGS

Illustrative embodiments of the invention are described in detail below with reference to the attached drawing figures, and wherein:

FIG. 1 is a perspective view of a nectar pouch for a bird feeder in accordance with an exemplary embodiment of the present invention having a capped opening at the upper end and a flexible tab in an extended position at the lower end.

FIG. 2 is a close-up, inverted partial view of the lower end of the nectar pouch of FIG. 1 showing the flexible tab in an extended position.

FIG. 3 is a close-up, inverted partial view of the lower end of the nectar pouch of FIG. 1 showing the flexible tab in a folded position.

FIG. 4 is a perspective view of the nectar bag of FIG. 1 showing the hinged tab at the lower end in a folded position.

FIG. 5 is a view of a hummingbird feeder in position for attachment to the nectar pouch of FIG. 1.

FIG. 6 is a perspective view of a hummingbird feeder attached to the inverted nectar bag of FIG. 1, with the hinged tab of the nectar pouch in an extended position for hanging the feeder/pouch assembly from a support.

FIG. 7 is a perspective view of a collection of nectar pouches arranged in a container.

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described. The terms “about” or “approximately” as used herein denote deviations from the exact value in the form of changes or deviations that are insignificant to the function.

Embodiments of the invention present a nectar pouch for use with a hummingbird feeder. Various features of the nectar pouch are disclosed and described.

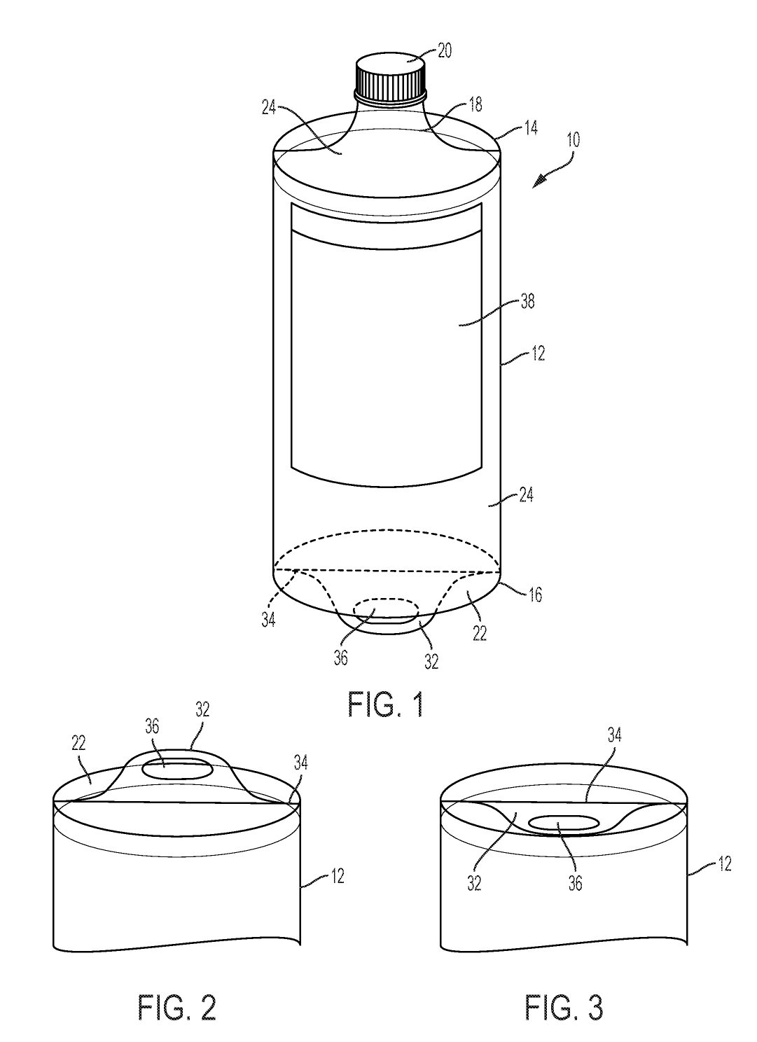

Looking first to FIG. 1, a nectar pouch in accordance with an exemplary embodiment of the present invention is depicted generally by the numeral 10. The nectar pouch 10 comprises a hollow cylindrical elongated main body 12 extending between first 14 and second 16 ends. As described in more detail below, a neck 18 and cap 20 closes the first end 14 of the body 12 and a base 22 closes the second end of the body to form an interior cavity 24 for containing a quantity of liquid nectar.

The circular shaped neck 18 extends outwardly and upwardly from the first end 14, with the sloped wall 24 forming the neck tapering from a large diameter at its lower portion originating at the first end 14 of the main body 12 to a smaller diameter at its distal end. As best seen in FIG. 5, the distal end of the neck 18 defines a circular opening 26 axially aligned with and in fluid communication with the interior cavity 24 of the nectar pouch 10. The outer surface of the neck 18 proximate and surrounding the circular opening 26 comprises tapered threads 28 formed on or in the outer surface, with the threads 28 configured to mate with corresponding threads on the interior surface of the cap 20 so that that the cap can be attached to the end of the neck 18 to cover the opening 26 and seal liquid nectar within the pouch for storage and shipping of the pouch containing nectar, the cap can similarly be removed to unseal the opening 26 to allow attachment of a bird feeder 30 having a similarly threaded receptacle 31 so that with the bird feeder attached and the pouch inverted, liquid nectar flows from the interior cavity 24, through the neck 18 and opening 26, and into the bird feeder 30.

A shallow, flattened U-shaped tab 32 is attached to the base 22 covering the lower end of the main body 12 at the second end 16 of the pouch, with the longer edge 34 of the tab hingedly attached along the diameter of the base 22. Tab 32 can thus be moved from an extended position in which it extends outwardly from and approximately perpendicular to the base 22, as shown in FIG. 2, and a folded position as shown in FIG. 3, in which the tab 32 lies substantially flush with the base 22.

An elongated slot or aperture 36 formed in the tab 32 allows insertion of a string, chain, hook or other securement means to permit the nectar pouch 10 to be attached to and suspended from a structure.

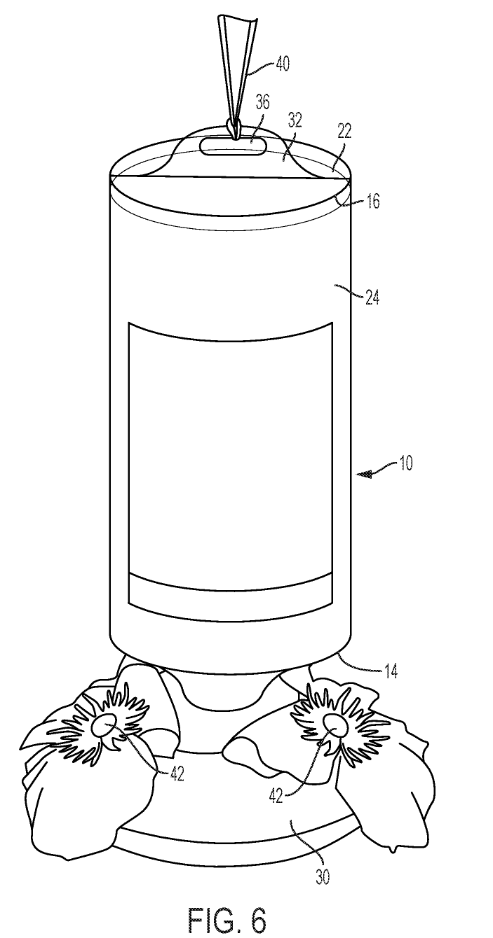

It should be understood that the terms “top” and “bottom” as used herein with respect to the nectar pouch 10 are relative with reference to the particular orientation of the nectar pouch. For example, with respect to FIGS. 1-5 and 7, the top of the nectar pouch 10 is the upper end of the depicted pouch, i.e., the first end 14 having the neck 18 and opening 26. In FIG. 6, the pouch 10 is inverted for use in conjunction with a birdfeeder 30, thus the “top” of the pouch in that view and configuration is the uppermost end, or second end 16 of the pouch.

Turning back to FIG. 1, a label 38 is affixed to the outer surface of the main body 12 to allow branding and a description of the product contained in the pouch 10.

Nectar pouch 10 is preferably formed from a clear, semi-rigid material, such as a plastic. Most preferably it is made from polyethylene terephthalate (PET). The pouch may be made by molding, by attaching component pieces, or by combinations thereof. Tab 32 is preferably attached to the base 22 by welding, but may alternatively be adhered to the base using a flexible adhesive, or may be formed integrally with the base. It is foreseen that the pouch could also be made of pliable material. The pouch could also be constructed of translucent, colored, or tinted materials depending on the application.

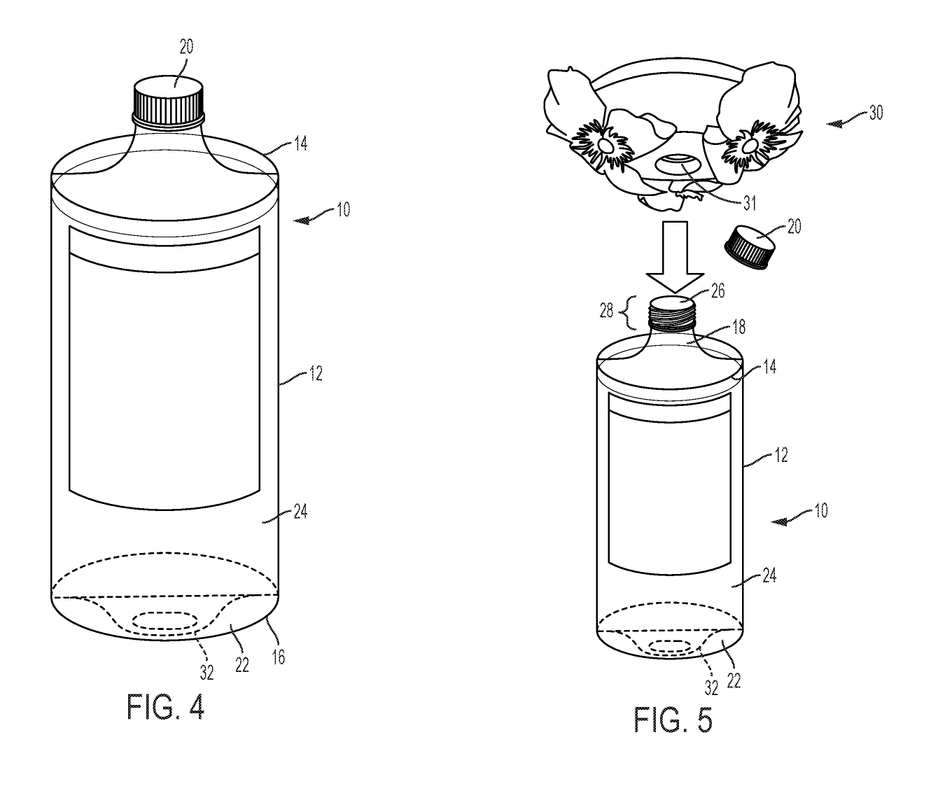

Looking to FIG. 4, for transit and storage, the tab 32 is folded essentially flush with the base 22 on the bottom of the pouch 10, allowing the pouch to sit upright on a shelf or table, or within a packing box. The nectar pouch 10 is filled with liquid nectar, and the top opening of the pouch is sealed with cap 20. Thus, the liquid nectar is contained within the pouch 10 in interior cavity 24, and the pouch can be moved, stored, transported, or carried without spillage. With the tab 32 folded flush against the bottom base 22, the nectar pouch 10 functions in a manner similar to a conventional can or bottle, and can be set upright on surfaces, etc.

Turning to FIGS. 5 and 6, the nectar pouch 10 can be directly used in conjunction with a bird feeder 30 by removing the cap 20 and attaching the feeder 30 to the threaded portion 28 of the neck 18. As seen in FIG. 6, with the nectar pouch 10 thus attached to the bird feeder 30, the entire pouch/feeder assembly is inverted, with the first end 14 of the pouch at the bottom, and the second end 14 of the pouch at the top. The tab 32 is positioned in its extended position, approximately perpendicular to the base 22. A string 40 or other hanging means is inserted through the slot 36 in the tab and attached to a structure (not shown) so that the pouch/feeder assembly is suspended in a desired location. With the assembly thus suspended, liquid nectar flows from the interior cavity 24 of the nectar pouch and into the bird feeder 30 where it is dispersed to nozzles or feeding stations 42 on the bird feeder where it is available to attracted hummingbirds.

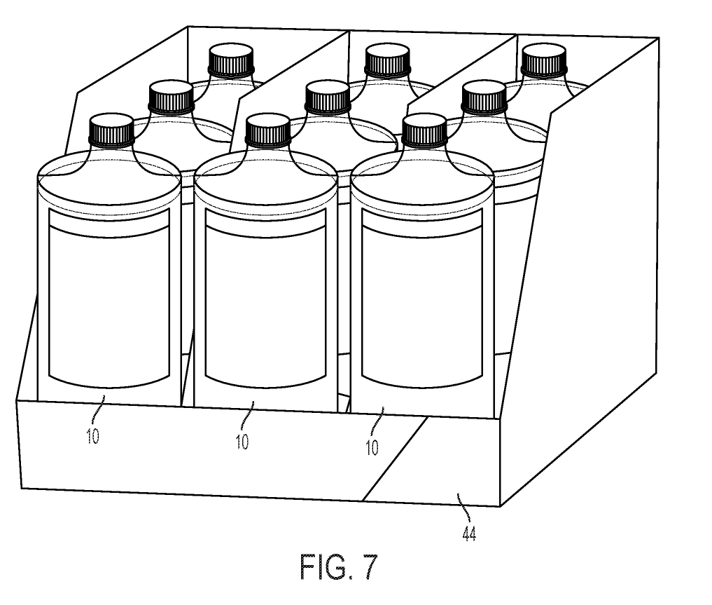

Looking to FIG. 7, a plurality of nectar pouches 10 are arranged in a packing container 44. With the tabs of each nectar pouch folded and flush with the base, the pouches 10 can be arranged and stacked in a conventional manner for packing and storage.

From the above, it can be seen that the nectar pouch of the present invention can be used, with the flap folded flush against the bottom of the pouch, to transport and store liquid nectar for hummingbird feeders in a conventional manner, with the pouch able to stand upright. Additionally, the pouch can be directly attached to a hummingbird feeder and, with the assembly inverted, the entire assembly can be suspended from the extended tab of the pouch. Thus, the pouch of the present invention eliminates the need to fill or refill a hummingbird feeder as the pouch is directly used with the feeder, and eliminates the need for additional hanging apparatus as the pouch as an integral tab that allows it to be directly hung or suspended as desired.

While the system and method of the present invention have been described herein with respect to an exemplary embodiment of a nectar pouch, it should be understood that features described are exemplary and not limiting. For example while the nectar pouch has been described as having a neck with threads for attachment to a cap and hummingbird feeder having similar corresponding threads, that other attachment means or mechanisms may equally be used without departing from the scope of the present invention. For example, the neck may be unthreaded, instead having an O-ring for press-fit insertion into a cap or hummingbird feeder having a corresponding mating fitting. These and other variations are within the scope of the present invention.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Identification of structures as being configured to perform a particular function in this disclosure and in the claims below is intended to be inclusive of structures and arrangements or designs thereof that are within the scope of this disclosure and readily identifiable by one of skill in the art and that can perform the particular function in a similar way. Certain features and sub-combinations are of utility and may be employed without reference to other features and sub-combinations and are contemplated within the scope of the claims.

What is claimed is:

1. A nectar pouch for use with a hummingbird feeder, comprising:
a main body having an outer wall extending between first and second ends defining an interior cavity for storing liquid nectar;
a neck extending from the first end having an opening therein in fluid communication with the interior cavity; and
a tab hingedly attached to the second end, the tab movable between an extended position in which the tab protrudes outwardly from the second end and a folded position in which the tab lies against the second end.

2. The nectar pouch of claim 1, wherein the neck is configured to removably mate with a hummingbird feeder.

3. The nectar pouch of claim 1, wherein the opening is circular and wherein the outer surface of the neck proximate the opening comprises tapered threads configured to attach to an apparatus having corresponding internal threads.

4. The nectar pouch of claim 3, wherein the apparatus comprises a cap or a hummingbird feeder.

5. The nectar pouch of claim 1, wherein the tab comprises an opening formed therethrough to allow hanging the nectar pouch from a structure.

6. The nectar pouch of claim 1, wherein the tab has a longer upper edge and a shorter flattened lower edge, and wherein the longer upper edge is hingedly attached to the second end.

7. A nectar pouch for use with a hummingbird feeder, comprising:
a cylindrical shaped main body having an outer wall extending between circular shaped first and second ends, the main body and ends defining an interior cavity for storing liquid nectar;
an opening formed in the first end in fluid communication with the interior cavity; and
a tab hingedly attached to the second end, the tab movable between an extended position in which the tab protrudes outwardly from the second end, and a folded position in which the tab lies flush against the second end to allow the main body to stand upright on the second end.

8. The nectar pouch of claim 7, further comprising a neck extending from the first end with the opening formed therethrough and wherein the neck comprises threads extending around the opening, the threads configured to receive a correspondingly threaded cap or hummingbird feeder.

9. The nectar pouch of claim 7, wherein the tab comprises an aperture formed therethrough.

10. The nectar pouch of claim 7, wherein the tab has a longer upper edge and a shorter flattened lower edge, and wherein the longer upper edge is hingedly attached to the second end.

11. A nectar pouch for use with a hummingbird feeder, comprising:
a hollow cylindrical main body having an outer wall extending between first and second ends defining an interior cavity for storing liquid nectar;
an opening defined in the first end in fluid communication with the interior cavity; and
a tab hingedly attached to the second end, the tab movable between an extended position in which the tab protrudes outwardly from the second end and a folded position in which the tab lies substantially flush against the second end.

12. The nectar pouch of claim 11, wherein the first end is configured to receive a removable cap to seal the opening.

13. The nectar pouch of claim 11, wherein the first end is configured to receive a hummingbird feeder to disperse liquid nectar from the inner cavity.

14. The nectar pouch of claim 11, wherein the tab comprises an aperture formed therethrough to permit the nectar pouch to be suspended from a structure.

15. The nectar pouch of claim 11, wherein the tab extends between a longer edge hingedly attached to the second end and a shorter unattached edge.
